(19) United States
(12) Patent Application Publication
(10) Pub. No.: US 2014/0380162 A1
(43) Pub. Date: Dec. 25, 2014

(54) VARIABLE AUDIOVISUAL PLAYING METHOD

(71) Applicant: Wu-Hsiung CHEN, Tainan City (TW)

(72) Inventor: Wu-Hsiung CHEN, Tainan City (TW)

(21) Appl. No.: 14/310,720

(22) Filed: Jun. 20, 2014

(30) Foreign Application Priority Data
Jun. 24, 2013 (TW) 102122341

(51) Int. Cl. G06F 3/0484

(52) U.S. Cl. CPC G06F 3/0484
USPC 715/716

(57) ABSTRACT

A variable audiovisual playing method is performed in a player. The method firstly provides a first information segment, a second information segment, to a n-th information segment. Each information segment has one or multiple different content clips. Secondly, the player sequentially plays the first information segment, the second information segment, to the n-th information segment. The content clip in each information segment for being played is randomly selected from the information segments or designated according to operation commands. The combination of the content clips for being played is different in each play.

### CROSS-REFERENCE TO RELATED APPLICATIONS

This application claims the benefit of Taiwan patent application No. 102122341, filed on Jun. 24, 2013, the disclosure of which is incorporated herein in its entirety by reference.

### BACKGROUND OF THE INVENTION

1. Field of the Invention

The present invention relates to a playing method, and more particularly to a variable audiovisual playing method.

2. Description of Related Art

Information playing technique is applied to business, movie industry, medical and education for providing the audiences with product introduction, films, voice or educational films.

Taking the movie industry as an example, filmmaking includes a pre-production stage, a production stage and a post-production stage. In the pre-production stage, a filmmaker formulates and constructs information for communicating to the audiences. With reference to FIG. 11, the pre-production stage means to create a narrative story 70. The scriptwriter transfers the story 70 into multiple scripts 71, 72, 73, 74 that are sequentially arranged. In the post-production stage, a director obtains individual film segments 711, 721, 731, 741 shot by cinematographers according to the scripts 71, 72, 73, 74. In the post-production stage, the film segments 711, 721, 731, 741 are successively edited to form a film 75.

In each film 75, because the narrative story is constructed during the pre-production stage, the plot of the film would not be changed after the post-production is completed. If an audience has watched the film before, the audience will not watch the film again. The rate of repeated viewing for the film with a single plot is very low. Same problem occurs in music, education videos, traveling guidance videos, bioenvironmental films, and medical treatment, and so on. The plots of them are single and are not varied.

Furthermore, an audiovisual file is a single digital file stored in a storage device. If a pirate wants to copy the audiovisual file, the pirate can easily obtain the audiovisual file via a download action. Hence, the audiovisual file is easily pirated, causing huge loss to the creators and providers who make the films or music. As a result, the conventional audiovisual producing method and playing method should be further improved.

### SUMMARY OF THE INVENTION

An objective of the present invention is to provide a variable audiovisual playing method for overcoming the drawbacks of the conventional playing method that only shows a single plot and is easily pirated.

The variable audiovisual playing method of the present invention is performed in a player. The method comprises:

providing multiple information segments from a first information segment to a n-th information segment, and each information segment comprising one or multiple different content clips, wherein n is a positive integer; and

sequentially playing the first information segment to the n-th information segment, wherein the content clip being played in each information segment is randomly selected or designated according to operation commands.

The method of the present invention upgrades the technique of playing information. Based on the multiple content clips with different contents, the content clips provide options when one of the information segments is played. In the process of sequentially playing the information segments, each content clip is randomly selected from its information segment or is designated according to the operation command, in connection with a previous information segment for continuously playing. The contents constructed by different combinations of the continued information segments in different plays are not single. The content in each play is varied and can be applied to more application fields.

Taking movie as example, the first information segment as the movie's opening includes one or multiple content clips. The content clip for being played in the first information segment can be randomly selected, or be designated according to the operation command. The movie's opening can show different contents in each play. Afterwards, the second information segment to the n−1 information segment respectively have one or multiple content clips. The content clip for being played in the following second information segment (till the n−1 information segment) is randomly selected, or designated according to the operation command, to be continuously connected after a previous information segment. Because the different content clips in different information segments have different contents, the whole movie can have different plots for each play. For the n-th information segment, the n-th information segment as the movie's ending has one or multiple content clips. The content clip in the n-th information segment is randomly selected to be played, or is designated to be played according to the operation command, thereby the movie's ending can have different contents in each play.

The content clip for being played in each information segment is randomly selected, or is designated according to the operation command for showing different plots. The audience can experience different openings, plots and endings to the movie in each time of viewing. Therefore, the audience would have the motivation to watch the movie again. The rate of repeated viewing for the movie will be increased.

Besides, the plots in each play are varied and different from each other, even if a pirate sequentially copies the movie at different times, the pirate cannot reproduce all information segments in combinations equivalent to the present invention. The movie is not a single digital file, but is composed of multiple information segments that are sequentially connected to each other. Even the movie edited by the method of the present invention only contains one single plot, the anti-piracy feature of the movie edited by the method of the present invention is still better than the conventional movie.

### BRIEF DESCRIPTION OF THE DRAWINGS

FIG. 1 is a system schematic drawing for performing the audiovisual playing method of the present invention;

FIG. 2 is another system schematic drawing for performing the audiovisual playing method of the present invention;

FIG. 3 is a flow chart of the audiovisual playing method of the present invention;

FIG. 4 is a schematic drawing for playing the information segments of the audiovisual playing method of the present invention;

FIG. 5 is a schematic drawing for playing the information segments of the audiovisual playing method of the present invention;

FIG. 6 is a schematic drawing for playing the information segments of the audiovisual playing method of the present invention;

FIG. 7 is a schematic drawing for playing the information segments of the audiovisual playing method of the present invention;

FIG. 8 is a schematic drawing for the audiovisual playing method of the present invention applied to movie editing;

FIG. 9 is a schematic drawing for the audiovisual playing method of the present invention applied to movie editing;

FIG. 10 is a schematic drawing for the audiovisual playing method of the present invention applied to movie editing; and

FIG. 11 is a flow chart of a conventional movie making method.

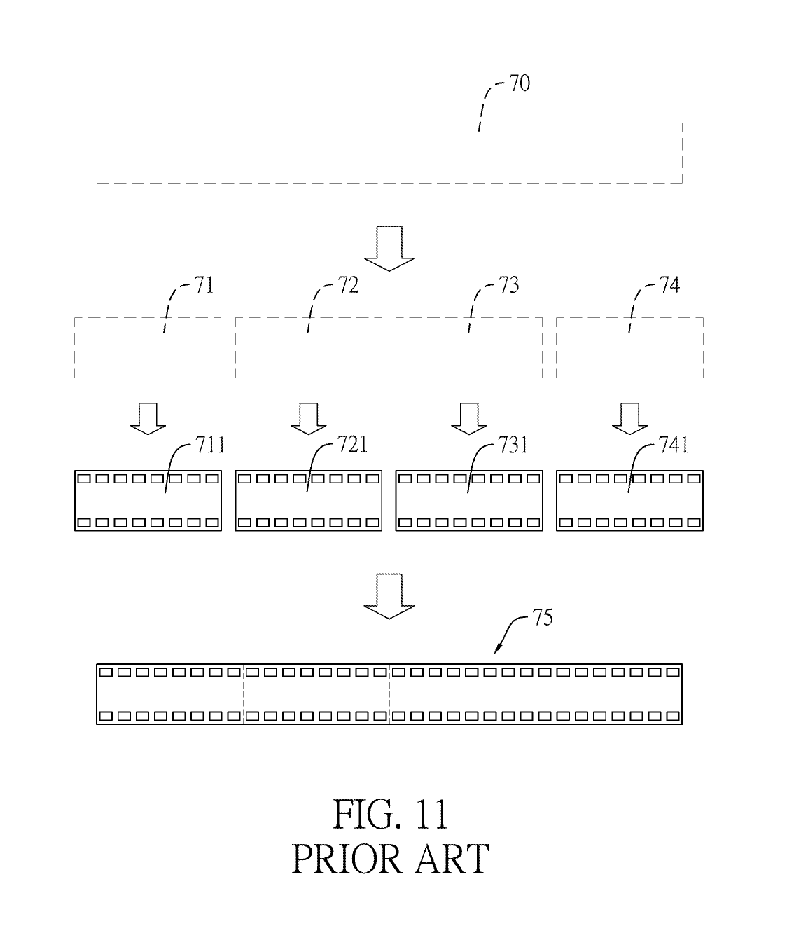

### DETAILED DESCRIPTION OF THE PREFERRED EMBODIMENT

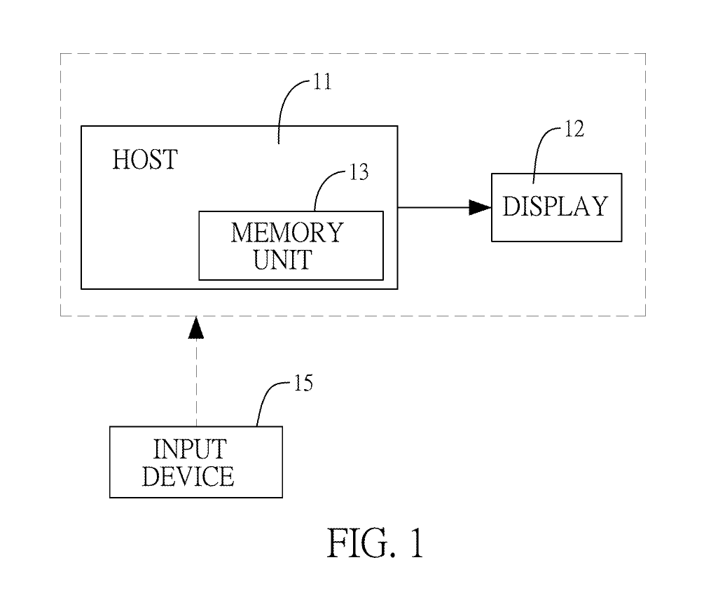

With reference to FIG. 1, the variable audiovisual playing method of the present invention is performed in a player. The player can be a video player or an audio player, such as a personal computer, a laptop, a tablet, a mobile phone, a MP3 player and a television. The player comprises a host 11. The host 11 can communicate with a projector or a display 12. In some embodiment, the player can be a combined player composed of the host 11 and the display 12. The player mentioned above can further wirelessly communicate with an input device 15 or communicate with the input device 15 via cables. The input device 15 can be a keyboard, a mouse, a touchpad, and so on, for a user to send an operation command to the host 11. Besides, the user can install applications to a mobile phone or a tablet. The mobile phone or the tablet can wirelessly communicate with the host 11 or communicate with the host 11 via cables to transmit the operation commands to the host 11.

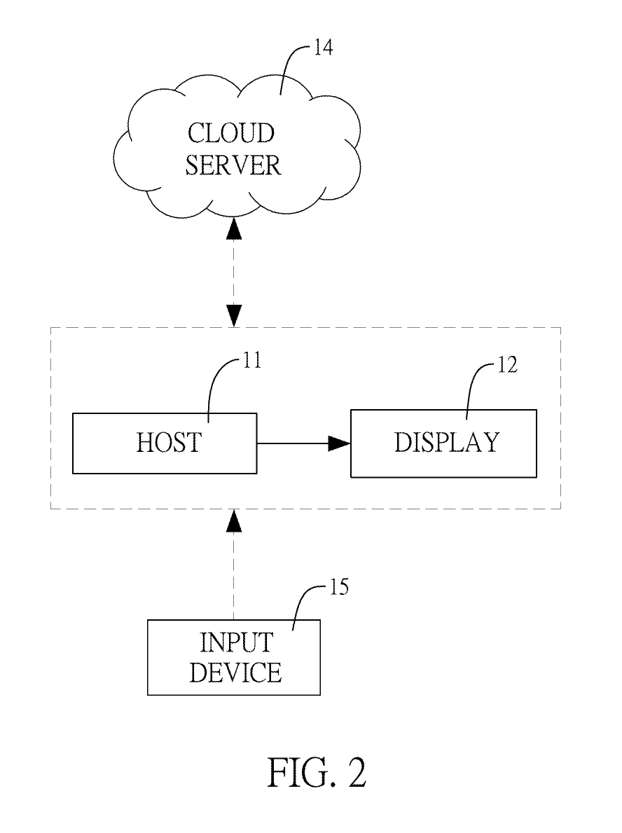

The host 11 has a memory unit 13. The memory unit 13 can be a hard disk drive (HDD), a memory card, a disk or other device that can store information, for storing one or multiple information segments. With reference to FIG. 2, in another embodiment, the host 11 wirelessly communicates with a cloud server 14 or communicates with the cloud server 14 via cables through the Internet to download the information segment from the cloud server 14.

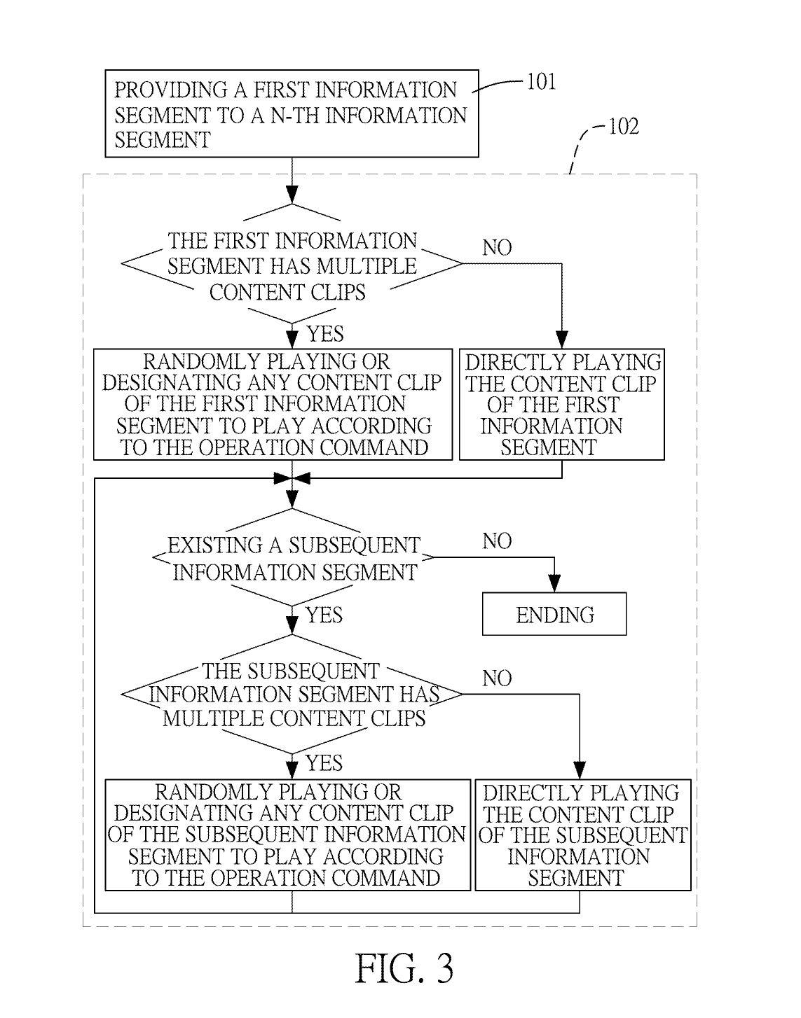

With reference to the flow charts disclosed in FIG. 1 and FIG. 3, a first step (101) of the present invention is to provide multiple information segments. The multiple information segments include a first information segment, a second information, to a n-th information segment, wherein n is a positive integer. Each information segment comprises one content clip or multiple content clips that respectively have different contents. The information segment mentioned above can be a video segment or an audio segment.

When the information segments are prepared, with reference to a second step (102) of FIG. 3, the host 11 can sequentially play the first information segment to the n-th information segment via a projector or a display 12. The content clip that is to be played in each information segment is randomly selected or selected according to an operation command. After the selected content clip in the final n-th information segment is played, the playing is ended.

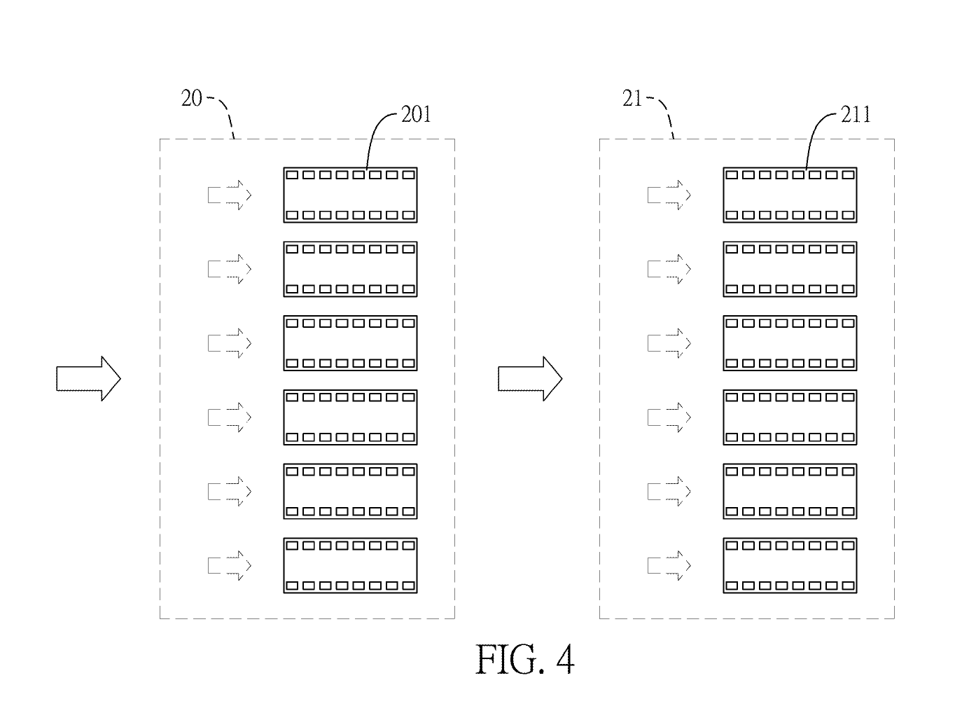

In the present invention, each information segment comprises one or multiple content clips. Contents of the multiple content clips are different from each other. FIGS. 4-7 disclose four embodiments wherein each information segment has multiple content clips. With reference to FIG. 4 of a first embodiment, when the first information segment is played, the host randomly selects any content clip 201 to be played. The dashed arrows illustrated in front of the content clips 201 indicate that the content clips 201 are randomly selected to be played, and hence the selection is unpredictable. The second information segment 21 has multiple content clips 211, such that after the first information segment 20 is ended and before the second information segment 21 begins to be played, the host also randomly selects any content clip 211 in the second information segment 21 to play. As a result, the content clip 211 in the second information segment 21 is continuously played after the content clip 201 in the first information segment 20.

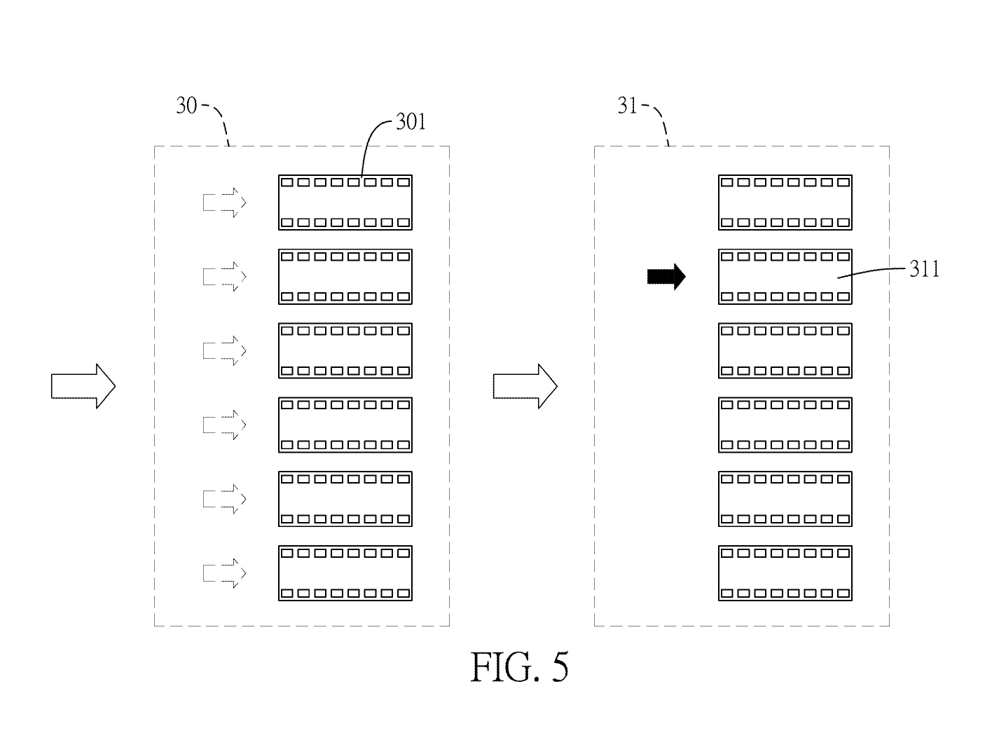

With reference to FIG. 5 of a second embodiment, the host randomly selects any content clip 301 in the first information segment 30 to play. After the first information segment 30 is ended and the second information segment 31 begins to be played, the content clip 311 for being played in the second information segment 31 is designated according to the operation command. The filled arrow illustrated in front of the content clip 311 indicates that the content clip 311 for being played is designated. As a result, the content clip 311 in the second information segment 31 is continuously played after the content clip 301 in the first information segment 30. With reference to FIG. 1 and FIG. 2, the operation command can be ordered by a user. The user can operate the input device 15 to transmit the operation command. When the host 11 receives the operation command, the host 11 selects the content clip 311 in the second information segment 31 according to the operation command.

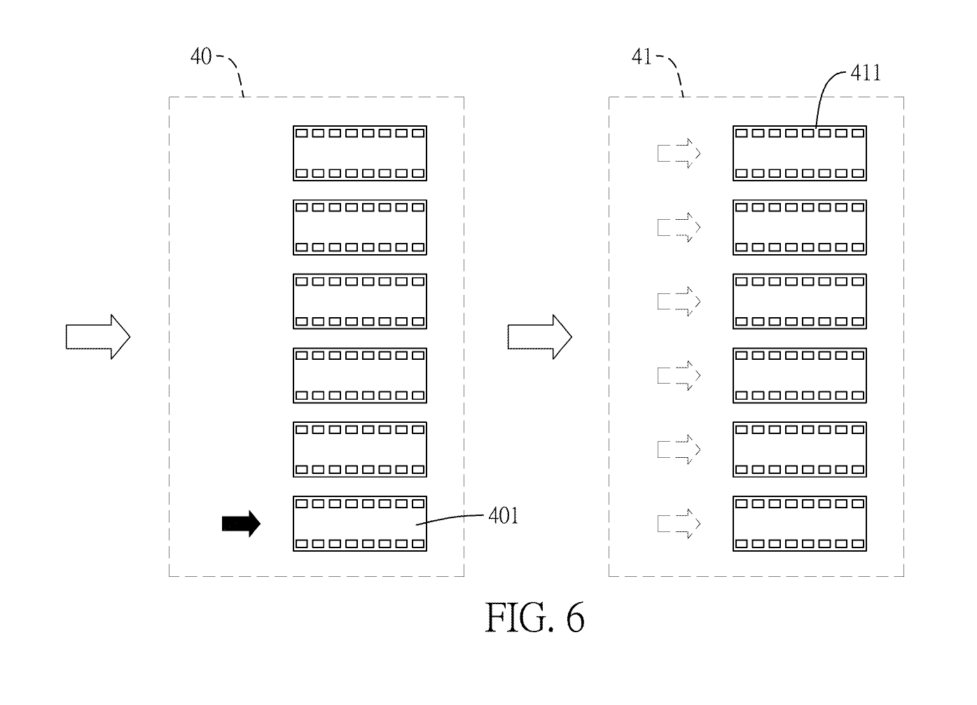

With reference to FIG. 6 of a third embodiment, the host designates one of the content clips 401 from the first information segment 40 to play according to the operation command. After the first information segment 40 is ended and before the second information segment 41 begins to be played, the host randomly selects one of the content clips 411 from the second information segment 41 to play. As a result, the content clip 411 in the second information segment 41 is continuously played after the content clip 401 in the first information segment 40.

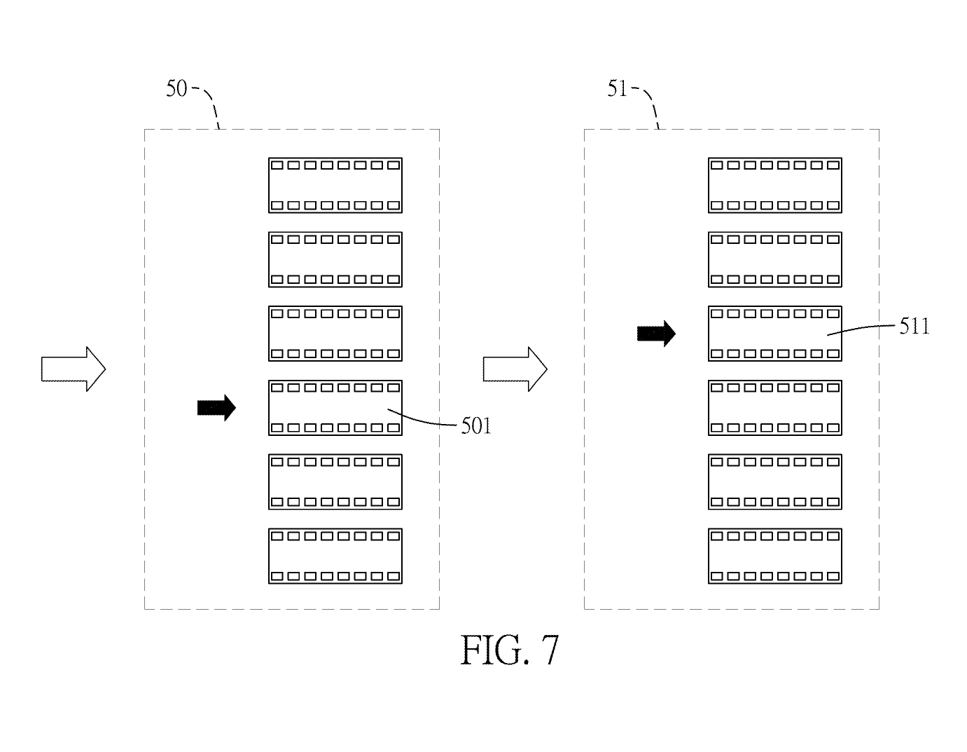

With reference to FIG. 7 of a fourth embodiment, the host designates one of the content clips 501 from the first information segment 50 to play according to the operation command. After the first information segment 50 is ended and before the second information segment 51 begins to be played, the host designates one of the content clips 511 from the second information segment 51 to play according to the operation command. As a result, the content clip 511 in the second information segment 51 is continuously played after the content clip 501 in the first information segment 50.

The four embodiments mentioned above are just examples for consecutive ones of the multiple information segments, wherein the first information segment is taken as a previous information segment and the second information segment is taken as a subsequent information segment. The operations of the following information segments after the second information segment can be deduced by analogy. Please note that when an information segment has only one content clip, the host would directly play that content clip. Regarding the variable audiovisual playing method of the present invention, the combinations of the content clips of the information segments are different for different plays.

Examples of applications of the present invention are described below.

(1) Movie

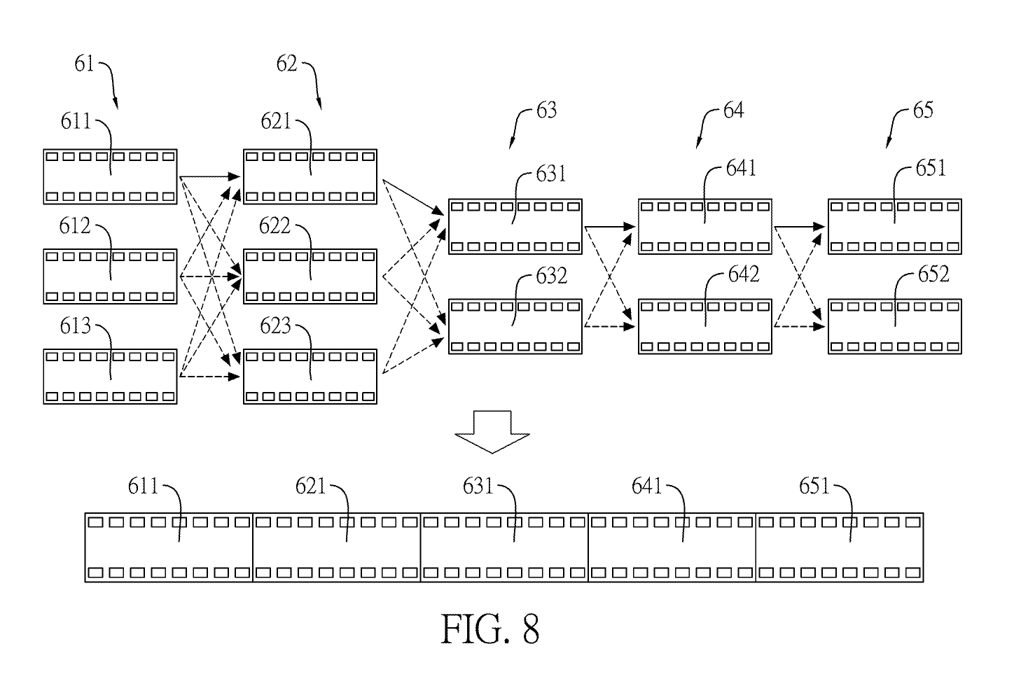

With reference to FIG. 8, n is supposed to be 5, such that there are a first information segment 61, a second information segment 62, a third information segment 63, a fourth information segment 64 and a fifth information segment 65 for forming a movie. The first information segment 61 has a first content clip 611, a second content clip 612 and a third content clip 613. The second information segment 62 has a first content clip 621, a second content clip 622 and a third content clip 623. The third information segment 63 has a first content clip 631 and a second content clip 632. The fourth information segment 64 has a first content clip 641 and a second content clip 642. The fifth information segment 65 has a first content clip 651 and a second content clip 652.

Supposed that the host 11 sequentially designates the first content clips 611, 621, 631, 641, 651 according to the operation commands from the information segments 61-65, a first plot sequentially shows the contents of the first content clips 611, 621, 631, 641, 651 from the information segments 61-65.

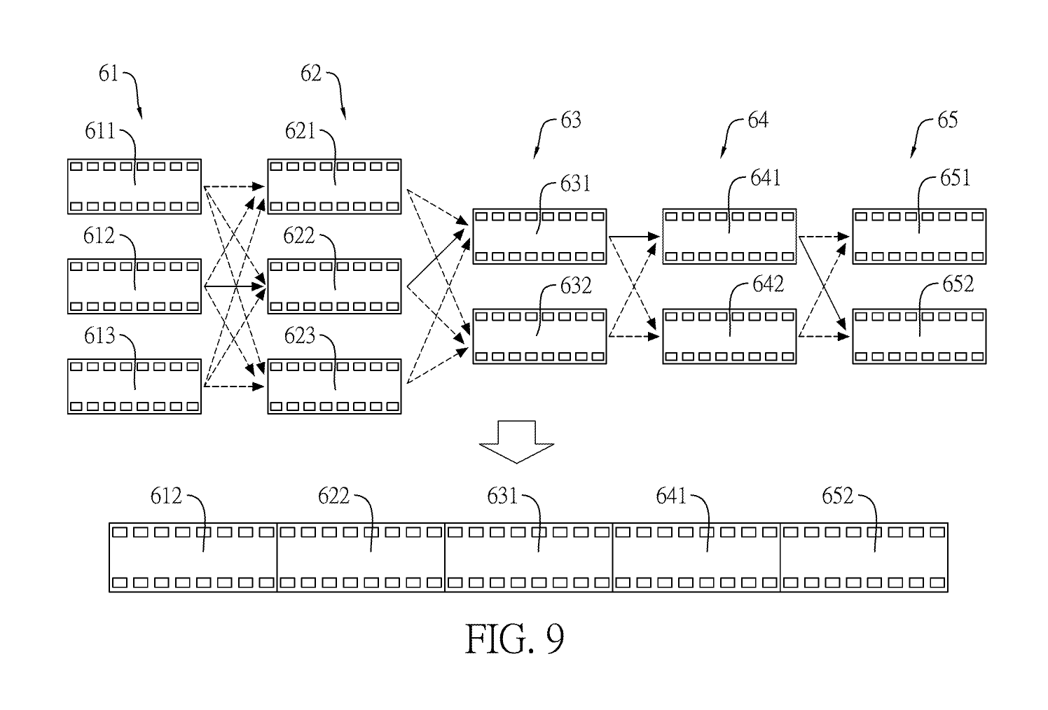

With reference to FIG. 9, supposed that the host 11 randomly selects the second content clip 612 from the first information segment 61, the second content clip 622 from the second information segment 62, the first content clip 631 from the third information segment 63, the first content clip 641 from the fourth information segment 64, and the second content clip 652 from the fifth information segment 65, a second plot sequentially shows the contents of the content clips 612, 622, 631, 641 and 652. Compared with the first plot of FIG. 8 with the second plot of FIG. 9, different storytelling models are shown.

Similarly, the host 11 can randomly select one content clip from an information segment or designate the content clip from an information segment according to the operation command, and then sequentially play the selected content clips from the five information segments. Hence, the combinations of the content clips in each play are varied.

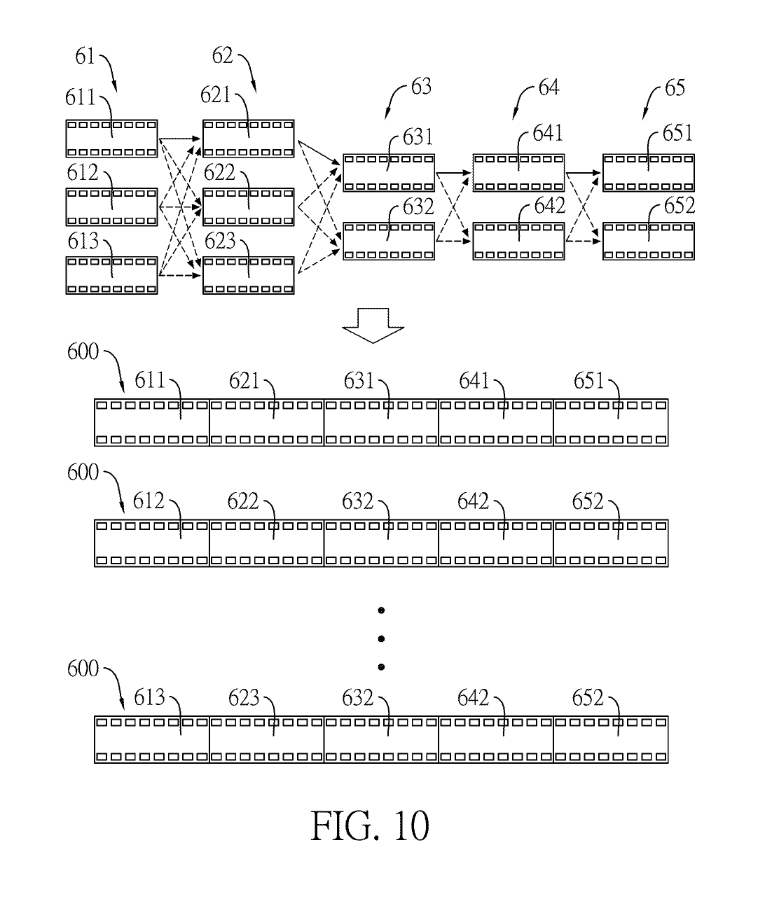

With reference to FIG. 10, because the five information segments 61-65 respectively have three, three, two, two and two content clips, the host 11 can produce 72 (3×3×2×2×2) combinations of plots that have different storytelling models for the audiences to watch. Each time the audience watches the movie, the movie can provide a different plot, which can raise the audience's motivation to watch the movie again.

The method of the present invention can be applied to microcinema, movie trailer or short film for providing different plots. The audience can view different plots when the audience watches the microcinema, movie trailer or short film played by the method for several times, thereby promoting economical benefit.

(2) Psychological State Estimation

The content clips of the five information segments can respectively provide joyful, sad, exciting, etc. contents for a testee.

When a medical personnel observes that the testee's mood is affected by the content clip during watching, with reference to FIG. 1, the medical personnel can operate the input device to transmit an operation command to the host. When the host 11 receives the operation command, the host 11 may select a content clip providing relaxing or relieving content in the next information segment for continuing after the previous information segment. Therefore, when the testee watches the next content clip, the testee would release the mood. Furthermore, the medical personnel can estimate and analyze the testee's psychological state by referring to the contents of the content clips viewed by the testee.

Besides being monitored by the medical personnel, the testee can be monitored by medical instruments. The testee's body is equipped with physiological sensors, such as a blood pressure monitor or a heart rate monitor, which are electrically connected to the host 11. The physiological sensors will generate physiologic signals based on the testee's psychological state and transmit the physiologic signals to the host 11. The host 11 can generate the operation command according to the physiologic signals to designate the content clip in the next information segment. For instance, when the testee is watching the movie and the testee's heart rate or blood pressure is above a threshold value, the host 11 can automatically select a content clip providing relaxing content in the next information segment for continuing playing after the previous information segment, thereby the testee's psychological state could be relieved.

(3) Memory Assessment and Training

The host 11 can produce multiple movies that have different plots. After the testee watches the different movies, the medical personnel can ask the testee to recall the details, the differences or common points from the movies to estimate or train the testee's memory capacity.

(4) Anti-Piracy

The host 11 can randomly select any content clip from the information segment or designate the content clip according to the operation command to produce multiple movies respectively having different plots. The movie would have different plots when the movie is replayed. Even though a pirate illegally copies the movie at different times, the pirate hardly collects all of the combinations of content clips of the movie. Hence, the plots of the pirated movie are not complete compared to the original movie, thereby an objective anti-piracy of is achieved.

In conclusion, the method of the present invention randomly selects any content clip from the information segment or designates the content clip from the information segment, and further continuously connects the content clips after a pervious information segment to form varied films or audio files. Each time the movie or the audio file is played, the same or different contents can be shown for enriching the contents to each movie, audio file, educational film, traveling guidance film, bioenvironmental film, medical film, and so on.

What is claimed is:

1. A variable audiovisual playing method performed in a player and comprising:
providing multiple information segments from a first information segment to a n-th information segment, and each information segment comprising one or multiple different content clips, wherein n is a positive integer; and
sequentially playing the first information segment to the n-th information segment, wherein the content clip being played in each information segment is randomly selected or designated according to operation commands.

2. The method as claimed in claim 1, wherein for two consecutive ones of the information segments, when each of the two consecutive ones of the information segments only comprises a single content clip, the two content clips of the two consecutive ones of the information segments are sequentially played.

3. The method as claimed in claim 1, wherein for two consecutive ones of the multiple information segments, when a previous information segment comprises a single content clip and a subsequent information segment comprises multiple content clips, the content clip of the previous information segment is directly played and one of the content clips of the subsequent information segment is randomly selected to be played.

4. The method as claimed in claim 1, wherein for two consecutive ones of the multiple information segments, when a previous information segment comprises a single content clip and a subsequent information segment comprises multiple content clips, the content clip of the previous information segment is directly played and one of the content clips of the subsequent information segment is designated to be played according to the operation command.

5. The method as claimed in claim 1, wherein for two consecutive ones of the multiple information segments, when a previous information segment comprises multiple content clips and a subsequent information segment comprises a single content clip, one of the content clips of the previous information segment is randomly selected to be played and the content clip of the subsequent information segment is directly played.

6. The method as claimed in claim 1, wherein for two consecutive ones of the multiple information segments, when a previous information segment comprises multiple content clips and a subsequent information segment comprises a single content clip, one of the content clips of the previous information segment is designated to be played according to the operation command and the content clip of the subsequent information segment is directly played.

7. The method as claimed in claim 1, wherein for two consecutive ones of the information segments, when each of the two consecutive ones of the information segments comprises multiple content clips, the content clips of the two consecutive ones of the information segments are randomly selected to be played.

8. The method as claimed in claim 1, wherein for two consecutive ones of the information segments, when each of the two consecutive ones of the information segments comprises multiple content clips, one of the content clips of a previous information segment is randomly selected to be played and one of the content clips of a subsequent information segment is designated to be played according to the operation command.

9. The method as claimed in claim 1, wherein for two consecutive ones of the information segments, when each of the two consecutive ones of the information segments comprises multiple content clips, one of the content clips of a previous information segment is designated to be played according to the operation command and one of the content clips of a subsequent information segment is randomly selected to be played.

10. The method as claimed in claim 1, wherein for two consecutive ones of the information segments, when each of the two consecutive ones of the information segments comprises multiple content clips, the content clips of the two consecutive ones of the information segments are designated to be played according to the operation commands.

11. The method as claimed in claim 1, wherein the information segments are video segments.

12. The method as claimed in claim 1, wherein the information segments are audio segments.
